(19) United States
(12) Patent Application Publication
(10) Pub. No.: US 2007/0244645 A1
(43) Pub. Date: Oct. 18, 2007

(54) Gas-condition predicting device and diffusion-condition predicting system

(75) Inventors: Tomohiro Hara, Nagasaki-ken (JP); Ryoji Ohba, Nagasaki-ken (JP); Kazuki Okabayashi, Nagasaki-ken (JP); Jiro Yoneda, Nagasaki-ken (JP); Akinori Kochi, Nagasaki-ken (JP); Shigehiro Nukatsuka, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 11/727,219

(22) Filed: Mar. 26, 2007

(30) Foreign Application Priority Data
Apr. 14, 2006 (JP) 2006-112215
Sep. 20, 2006 (JP) 2006-254163

(51) Int. Cl. G06F 19/00; G06F 17/40

(52) U.S. Cl. 702/3; 703/6; 703/9; 702/1; 702/2; 702/45; 702/50

(57) ABSTRACT

A gas-condition predicting device includes an auxiliary storage device for storing each atmospheric condition in association with gas flow-field data in a target area under the atmospheric condition; a meteorological-modeling unit for calculating, using a meteorological model calculation, meteorological parameters at a plurality of evaluation points defined in an enlarged area that includes the target area and that is larger than the target area; and an extraction unit for determining atmospheric conditions in the target area from the meteorological parameters calculated by the meteorological-modeling unit and extracting from the auxiliary memory device gas flow-field data corresponding to the atmospheric conditions.

### BACKGROUND OF THE INVENTION

1. Field of the Invention

The present invention relates to a gas-condition predicting device, a gas-condition predicting method, and a gas-condition predicting program for spatially and temporally determining dense gas conditions (such as wind direction and wind speed) from spatial and temporal approximate weather observation data, and to a diffusion-condition predicting system.

This application is based on Japanese Patent Applications, Nos. 2006-112215 and 2006-254163, the contents of which are incorporated herein by reference.

2. Description of Related Art

Heretofore, diffusion-condition predicting systems have been known. When a radioactive material is released due to an accident from a facility treating nuclear materials, such diffusion-condition predicting systems predict the diffusion area and the diffusion concentration of the radioactive material to predict affected areas.

In such a diffusion-condition predicting system, first, partial differential equations for analyzing atmospheric phenomena are calculated on the basis of observed weather data, such as meteorological grid point values (GPV) data or data from the automated meteorological data acquisition system (AMEDAS). Thereby, air-flow parameters (such as wind direction and wind speed) at a large number of evaluation points are determined at predetermined time intervals over a calculation period to a predetermined time after the occurrence of the accident (for example, the release of a radioactive material). Diffusion calculations are then performed using these air-flow parameters to predict diffusion conditions of the substance released from the source of the accident.

For example, Japanese Unexamined Patent Application, Publication No. 2002-202383 proposes the technique described below.

First, as shown in FIG. 8, when air-flow parameters around, for example, a nuclear power plant etc. must be predicted in a dense manner, a predetermined area including the point at which the nuclear power plant is located (for example, the point indicated by X in the figure) is defined as a specified area A3. Subsequently, a plurality of enlarged areas A2 (A2>A3, hereinafter referred to as “medium area”) and A1 (A1>A2, hereinafter referred to as “large area”) that include the specified area A3 and whose areas are extended stepwise are defined. For example, the large area A1 is defined so as to have an area of 500 square kilometers, the medium area A2 is defined so as to have an area of 100 square kilometers, and the specified area A3 is defined so as to have an area of 50 square kilometers.

In each of the specified area A3, the medium area A2, and the large area A1, evaluation points for evaluating the air-flow parameters are defined. For example, in the large area A1, the evaluation points are defined in a grid shape at distance intervals of 4 km in the east-west direction and in the north-south direction. Similarly, in the medium area A2, the evaluation points are defined in a grid shape at distance intervals of 1 km in the east-west direction and in the north-south direction. In the specified area A3, the evaluation points are defined in a grid shape at distance intervals of 250 m in the east-west direction and in the north-south direction.

When the air-flow parameters are predicted in the large area A1, the medium area A2, and the specified area A3, first, the air-flow parameters at each evaluation point defined in the large area A1, which is the largest area, are calculated on the basis of observed weather data. Here, for example, a specific description will be made of a case where meteorological GPV data is used as the observed weather data.

First, data obtained by performing spatial interpolation of the GPV data is used as initial conditions, and data obtained by performing spatial and temporal interpolations of the GPV data is used as boundary conditions. By solving partial differential equations relating to atmospheric phenomena using this data, the air-flow parameters at each evaluation point in the large area A1 are calculated.

Subsequently, air-flow parameters at evaluation points in the medium area A2 are calculated by the following procedure. First, among the evaluation points in the medium area A2, at evaluation points located at the same positions as the evaluation points defined in the large area A1, since the data has been calculated in the calculation in the large area A1, the data is diverted without further processing to serve as initial conditions. At other evaluation points, data obtained by interpolating the above diverted data is used as the initial conditions. Next, among the evaluation points around the boundary of the medium area A2, at evaluation points located at the same positions as the evaluation points defined in the large area A1, the data in the large area A1 is diverted without further processing to serve as boundary conditions. At other evaluation points around the boundary, data obtained by interpolating the above diverted data is used as the boundary conditions. By solving partial differential equations relating to atmospheric phenomena using these initial conditions and boundary conditions, the air-flow parameters at each evaluation point are calculated.

Similarly, initial conditions and boundary conditions at evaluation points in the specified area A3 are determined by the same procedure as that in the medium area A2. By solving partial differential equations relating to atmospheric phenomena using the determined initial conditions and boundary conditions, the air-flow parameters at each evaluation point are calculated.

As described above, since grid points having a small distance interval, that is, the finest evaluation points, are defined only in the small area (specified area) A3, which requires dense air-flow parameters, the processing time can be decreased compared with the case where detailed evaluation points are defined in the entire area of the large area A1.

Furthermore, according to the technique disclosed in Japanese Unexamined Patent Application, Publication No. 2002-202383, when air-flow parameters are continuously predicted in the large area A1, the medium area A2, and the specified area A3 over a calculation period to a predetermined time after the calculation start time, the calculation period is divided into a plurality of divided calculation periods, and the calculations in each divided calculation period are assigned to a plurality of calculation units and performed in parallel, thereby decreasing the calculation time.

Furthermore, recently, a method of calculating air-flow parameters more precisely has been proposed. This method calculates air-flow parameters in an area of several square kilometers by nesting method described above and then calculates air-flow parameters around buildings at intervals of several meters using a computational fluid dynamics (CFD) model.

However, since the above method of calculating air-flow parameters requires a considerably long calculation time, the method is difficult to employ in actual situations and is less feasible.

### BRIEF SUMMARY OF THE INVENTION

An object of the present invention is to provide a gas-condition predicting device, a gas-condition predicting method, a gas-condition predicting program, and a diffusion-condition predicting system in which the processing time can be decreased.

According to a first aspect of the present invention, a gas-condition predicting device for predicting gas conditions in a target area including a target point includes a storage unit for storing each atmospheric condition in association with gas flow-field data in the target area under the atmospheric condition; a meteorological-modeling unit for calculating, using a meteorological model calculation, meteorological parameters at a plurality of evaluation points defined in an enlarged area that includes the target area; and an extraction unit for determining atmospheric conditions in the target area from the meteorological parameters calculated by the meteorological-modeling unit and extracting from the storage unit gas flow-field data corresponding to the atmospheric conditions.

According to this structure, the meteorological parameters at a plurality of evaluation points defined in the enlarged area including the target area are calculated by the meteorological-modeling unit. Subsequently, atmospheric conditions in the target area are determined on the basis of the meteorological parameters, and gas flow-field data corresponding to these atmospheric conditions is extracted from the storage unit. Accordingly, gas flow-field data in which the atmospheric conditions in the target area are reflected can be easily obtained.

As described above, since atmospheric conditions and gas flow-field data of the target area under the atmospheric conditions are stored in the storage unit in advance, the meteorological-modeling unit need not calculate the gas flow-field by the meteorological model calculation to the level of the target area, thus reducing the processing time.

The gas flow-field data is, for example, three-dimensional gas flow-field data including at least one meteorological parameter such as wind direction, wind speed, turbulence energy, humidity, and temperature.

Examples of the meteorological model calculation method employed by the meteorological-modeling unit include the regional atmospheric modeling system (RAMS), the mesoscale model 5 (MM5), and the weather research and forecasting (WRF) model. The term “meteorological parameter” means, for example, at least one of air temperature, air pressure, humidity, wind direction, wind speed, turbulence energy, the amount of precipitation, the amount of cloud, the type of cloud, solar insulation, radiation, sunshine, the range of visibility, and the amount of snowfall.

The enlarged area includes an area including the target area; that is, the enlarged area may correspond to the target area. However, evaluation points in the enlarged area are roughly defined compared with those in the target area.

The extraction unit may extract meteorological parameters at a single point corresponding to the target area within the enlarged area, the meteorological parameters being calculated by the meteorological-modeling unit, and determine the atmospheric conditions on the basis of the meteorological parameters. For example, when the atmospheric conditions are determined by a combination of wind direction and atmospheric stability, the wind direction is determined by extracting wind direction among the meteorological parameters, and the atmospheric stability is determined from wind speed and the amount of solar radiation or the amount of radiation budget. The extraction unit then extracts from the storage unit gas flow-field data that is associated with the atmospheric conditions determined from the wind direction and the atmospheric stability.

Alternatively, the extraction unit may extract, from the meteorological parameters in the enlarged area calculated by the meteorological-modeling unit, meteorological parameters at a plurality of evaluation points corresponding to the target area, for example, meteorological parameters in the boundary of the target area, and may determine the atmospheric conditions of the target area on the basis of these extracted meteorological parameters, for example, by averaging the meteorological parameters.

In the gas-condition predicting device, the extraction unit may determine the atmospheric conditions in the target area from the meteorological parameters calculated by the meteorological-modeling unit, may extract from the storage unit two types of gas flow-field data close to the atmospheric conditions, and may perform linear combination of the two types of extracted gas flow-field data to calculate the gas flow-field data in the target area.

According to this structure, the gas flow-field data in the target area is calculated by determining the atmospheric conditions in the target area from the meteorological parameters calculated by the meteorological-modeling unit, extracting from the storage unit two types of gas flow-field data close to the atmospheric conditions, and performing linear combination of the two types of extracted gas flow-field data. Accordingly, more accurate gas flow-field data can be calculated. By performing a diffusion calculation using this gas flow-field data, the accuracy of the diffusion calculation can be improved.

The gas-condition predicting device may further include an output unit for outputting the gas flow-field data extracted or calculated by the extraction unit.

According to this structure, the gas flow-field data in the target area extracted by the extraction unit is output via the output unit. Thereby, a diffusion calculation using this gas flow-field data can be executed.

The gas-condition predicting device may further include a correction unit for correcting the gas flow-field data extracted or calculated by the extraction unit using the meteorological parameters calculated by the meteorological-modeling unit.

According to this structure, the gas flow-field data in the target area is corrected using meteorological parameters at an evaluation point in the enlarged area determined by the meteorological-modeling unit, and thus the meteorological parameters are reflected in the gas flow-field data.

Furthermore, the gas flow-field data extracted from the storage unit is gas flow-field data in which meteorological parameters at that time are reflected. In addition, this gas flow-field data is corrected using the meteorological parameters at that time. Therefore, highly accurate gas flow-field data can be obtained.

In the gas-condition predicting device, the correction unit may assimilate the meteorological parameters of the target area included in the enlarged area and the gas flow-field data extracted from the extraction unit.

By assimilating the meteorological parameters of the target area included in the enlarged area and the gas flow-field data extracted from the extraction unit, the results of the meteorological model calculation can be easily reflected in the gas flow-field data.

Examples of the calculation method used for the assimilation include a nudging method and a least squares method. The assimilation may be performed for all meteorological parameters in the target area calculated by the meteorological-modeling unit. Alternatively, the assimilation may be performed for only meteorological parameters in the boundary of the target area.

In the gas-condition predicting device, the correction unit may perform an assimilation using at least one of wind components and turbulence energy of the gas flow-field data.

In the diffusion calculation, which is subsequent processing, the wind components and the turbulence energy are used as main meteorological parameters. Therefore, by performing the assimilation using at least one of the wind components and the turbulence energy, gas flow-field data suitable for the subsequent diffusion calculation can be obtained.

The gas-condition predicting device may further include an output unit for outputting the gas flow-field data obtained after the correction by the correction unit.

According to this structure, the gas flow-field data in the target area corrected by the correction unit is output via the output unit. Thereby, a diffusion calculation using this gas flow-field data can be executed.

The gas flow-field data may be determined using a computational fluid dynamics (CFD) model.

Since the gas flow-field data in the target area is determined using a computational fluid dynamics (CFD) model, dense data in which the shape of buildings or the like is considered can be obtained.

Examples of the computational fluid dynamics (CFD) model include the K-epsilon (K·ε) model, large-eddy simulation (LES), and direct numerical simulation (DNS).

Furthermore, the gas-condition predicting device of the present invention is suitable for use in a diffusion-condition predicting system. In this diffusion-condition predicting system, by performing a diffusion calculation using the gas flow-field data determined by the gas-condition predicting device, the conditions of a gas diffused from a target point can be predicted with high accuracy.

According to a second aspect of the present invention, a gas-condition predicting method for predicting gas conditions in a target area including a target point includes a meteorological-parameter calculation step of calculating, using a meteorological model calculation, meteorological parameters at a plurality of evaluation points defined in an enlarged area that includes the target area; an atmospheric-condition determination step of determining atmospheric conditions of the target area on the basis of the meteorological parameters calculated in the meteorological-parameter calculation step; and an extraction step of extracting gas flow-field data corresponding to the atmospheric conditions determined in the atmospheric-condition determination step from a storage device in which each atmospheric condition is associated with gas flow-field data in the target area under the atmospheric condition in advance.

According to a third aspect of the present invention, a gas-condition predicting program for predicting gas conditions in a target area including a target point, the gas-condition predicting program causing a computer to execute meteorological-parameter calculation processing for calculating, using a meteorological model calculation, meteorological parameters at a plurality of evaluation points defined in an enlarged area that includes the target area; atmospheric-condition determination processing for determining atmospheric conditions of the target area on the basis of the meteorological parameters calculated in the meteorological-parameter calculation processing; and extraction processing for extracting gas flow-field data corresponding to the atmospheric conditions determined in the atmospheric-condition determination processing from a storage device in which each atmospheric condition is associated with gas flow-field data in the target area under the atmospheric condition in advance.

The present invention affords an advantage of reducing the processing time.

### BRIEF DESCRIPTION OF THE SEVERAL VIEWS OF THE DRAWINGS

FIG. 1 is a block diagram showing the outline structure of a diffusion-condition predicting system according to a first embodiment of the present invention.

FIG. 2 is a table showing an example of data stored in an auxiliary storage device shown in FIG. 1.

FIG. 3 is a diagram showing an example of setting evaluation points in a target area.

FIG. 4 is a functional block diagram of the diffusion-condition predicting system according to the first embodiment of the present invention.

FIG. 5 is a flowchart showing a procedure of a gas-condition predicting method realized in a gas-condition predicting device shown in FIG. 4.

FIG. 6 includes views showing the relationship between enlarged areas and a target area according to the first embodiment of the present invention.

FIG. 7 is a view illustrating the function of an extraction unit of a diffusion-condition predicting system according to a second embodiment of the present invention.

FIG. 8 includes views illustrating a known diffusion-condition predicting system.

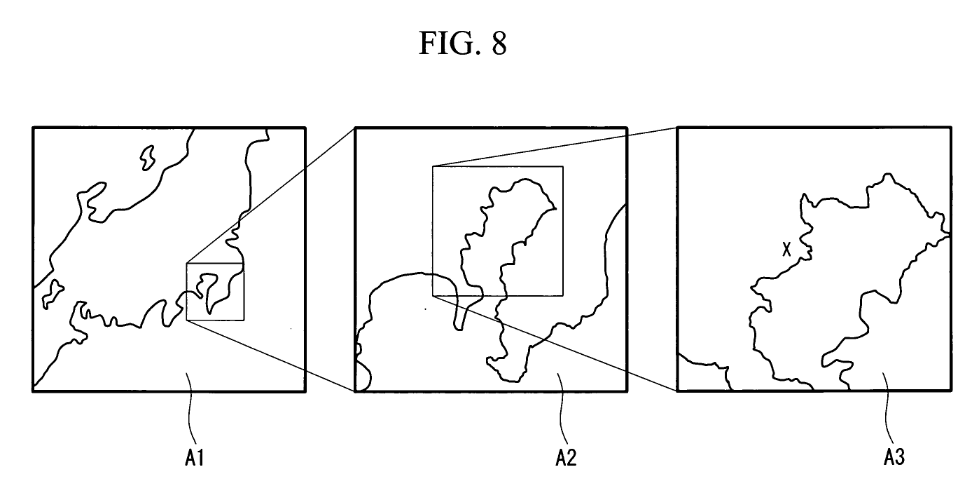

### DETAILED DESCRIPTION OF THE INVENTION

A diffusion-condition predicting system according to an embodiment of the present invention will now be described with reference to the drawings.

### First Embodiment

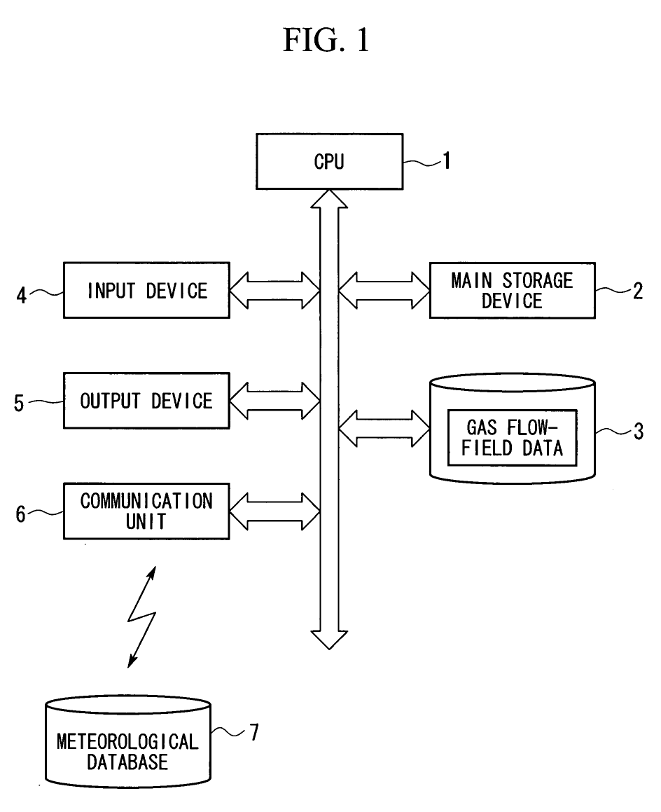

FIG. 1 is a block diagram showing the outline structure of a diffusion-condition predicting system according to a first embodiment of the present invention. The diffusion-condition predicting system of this embodiment predicts gas conditions in a target area, which is a predetermined area including a target point X at which a nuclear power plant or the like is located, and predicts diffusion conditions of a diffusate released from the target point X using the predicted gas conditions.

This diffusion-condition predicting system is a computer system including a central processing unit (CPU) 1, a main storage device 2 such as a random access memory (RAM), an auxiliary storage device (storage unit) 3 such as a read only memory (ROM) or a hard disk drive (HDD), an input device 4 such as a keyboard or a mouse, an output device 5 such as a display or a printer, a communication unit 6 that communicates with an external device, and the like.

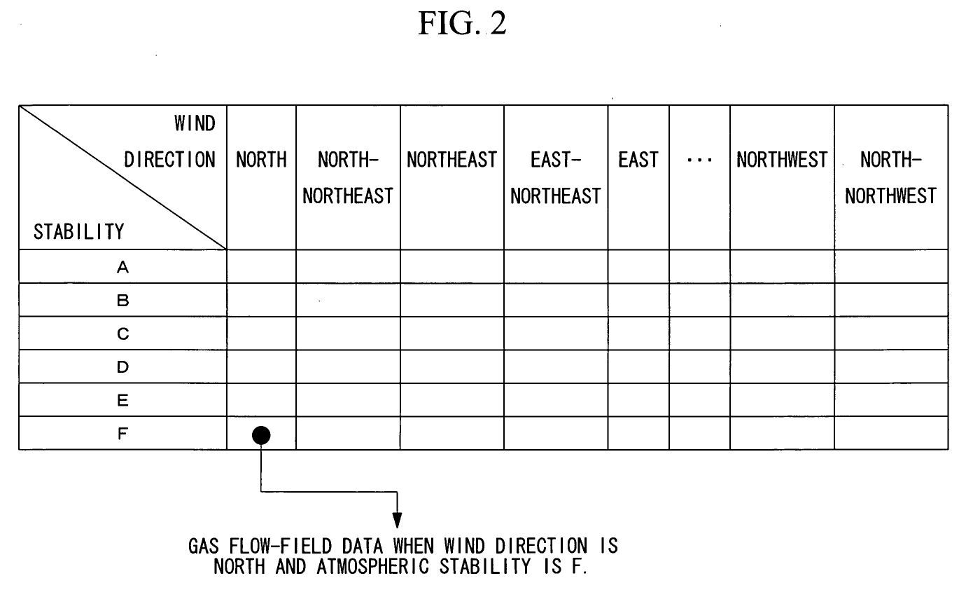

In the auxiliary memory device 3, each atmospheric condition is stored in association with gas flow-field data in the target area under the atmospheric condition. The atmospheric conditions are determined by, for example, a combination of wind direction and atmospheric stability. In this embodiment, as shown in FIG. 2, sixteen wind directions are defined and the atmospheric stability is set to one of six levels A to F.

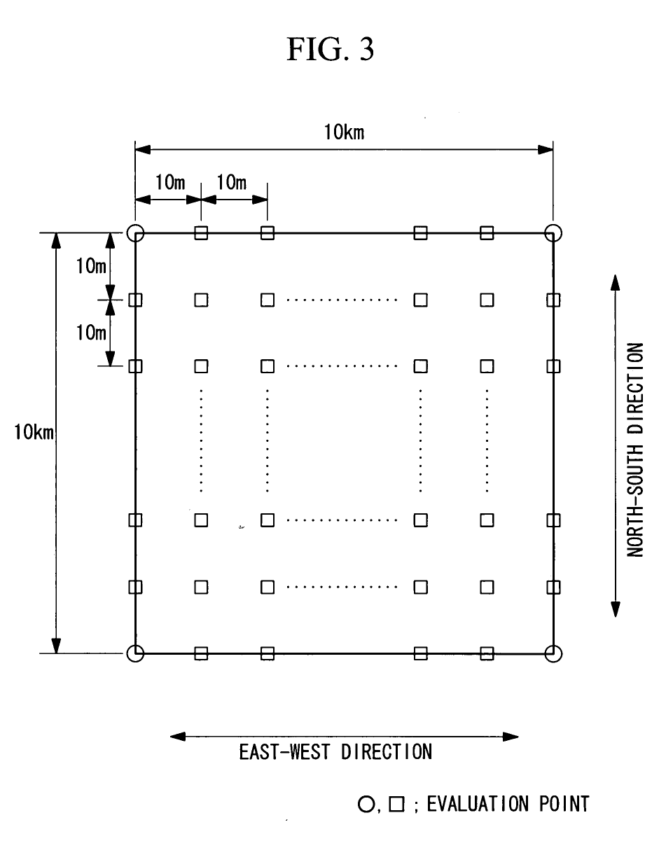

The gas flow-field data is three-dimensional gas flow-field data in the target area including the target point and is calculated using a computational fluid dynamics (CFD) model in consideration of, for example, buildings in and the topography of the target area. As shown in FIG. 3, the target area is set to, for example, an area in the range of about 1 to 10 square kilometers (FIG. 3 shows the case of 10 km). In this target area, evaluation points of the gas flow-field are defined in a grid shape at distance intervals in the range of 1 to 10 m (FIG. 3 shows the case of 10 m).

In calculating the gas flow-field, the diffusion-condition predicting system determines various meteorological parameters such as wind direction, wind speed, turbulence energy, humidity, and temperature at each evaluation point. More specifically, the diffusion-condition predicting system calculates the gas flow-field at each evaluation point defined in the target area using the computational fluid dynamics (CFD) model under meteorological conditions of all combinations determined by the above sixteen wind directions and six levels of atmospheric stability, i.e., 96 (=16×6) types of meteorological conditions, and stores the gas flow-field data resulting from the calculation in the auxiliary memory device 3 in association with atmospheric conditions at which the gas flow-field data is obtained.

The communication unit 6 has a function capable of connecting to a meteorological database 7 installed on a network. Meteorological data from the past and predictive meteorological data in the future are stored in the meteorological database 7. Examples of the meteorological data include grid point values (GPV) and AMEDAS data.

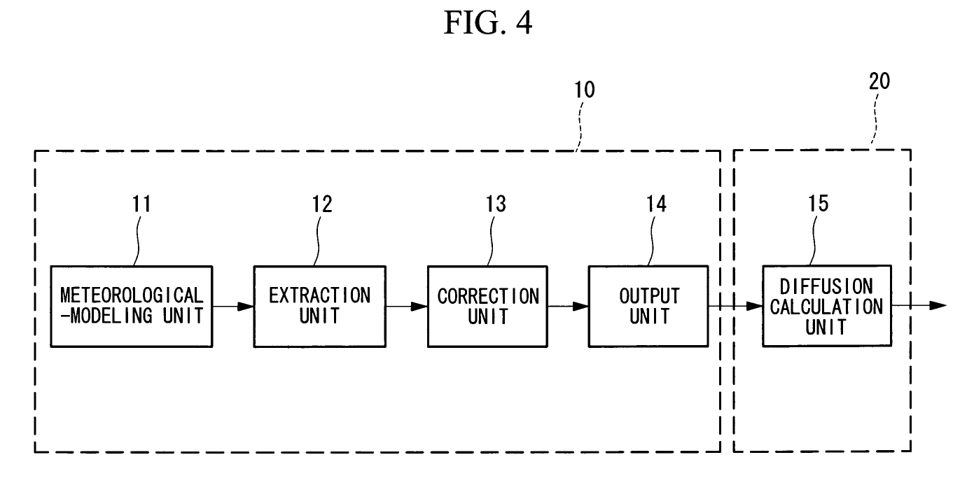

The gas diffusion prediction at a target point performed by the diffusion-condition predicting system having the above-described structure will now be described with reference to FIG. 4.

FIG. 4 is a functional block diagram of the diffusion-condition predicting system according to this embodiment. As shown in FIG. 4, the diffusion-condition predicting system includes a gas-condition predicting device 10 for predicting gas conditions and a diffusion-condition predicting device 20 for predicting diffusion conditions of a substance.

The gas-condition predicting device 10 includes a meteorological-modeling unit 11, an extraction unit 12, a correction unit 13, and an output unit 14. The meteorological-modeling unit 11 calculates meteorological parameters, using a meteorological model, at a plurality of evaluation points defined in enlarged areas that include a target area and that are larger than the target area. The extraction unit 12 determines atmospheric conditions in the target area from the meteorological parameters calculated by the meteorological-modeling unit 11 and extracts from the auxiliary memory device 3 gas flow-field data corresponding to the atmospheric conditions. The correction unit 13 corrects the gas flow-field data extracted from the extraction unit 12 using the meteorological parameters calculated by the meteorological-modeling unit 11. The output unit 14 outputs the gas flow-field data corrected by the correction unit 13 to a diffusion calculation unit 15 of the diffusion-condition predicting device 20.

The CPU 1 included in the diffusion-condition predicting system reads out a gas-condition predicting program stored in the auxiliary storage device 3 to a RAM or the like and executes the program, thereby implementing the various functions of the above units.

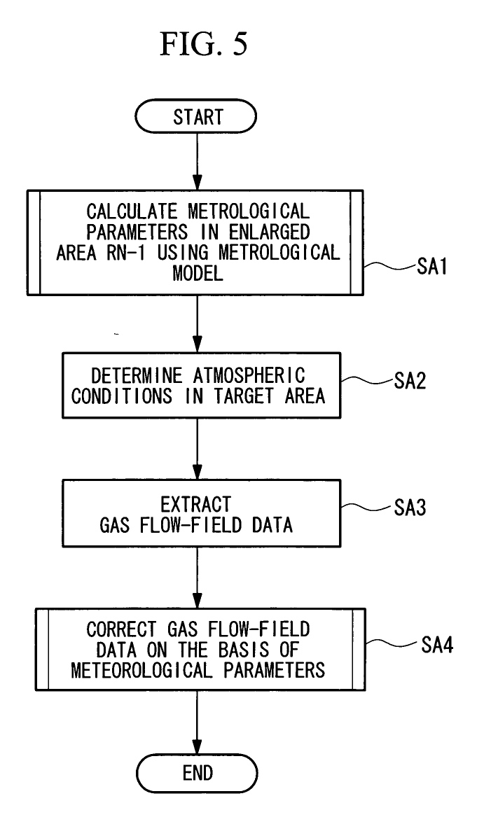

A gas-condition predicting method and a diffusion-condition predicting method realized by the diffusion-condition predicting system will now be described with reference to FIGS. 4 and 5.

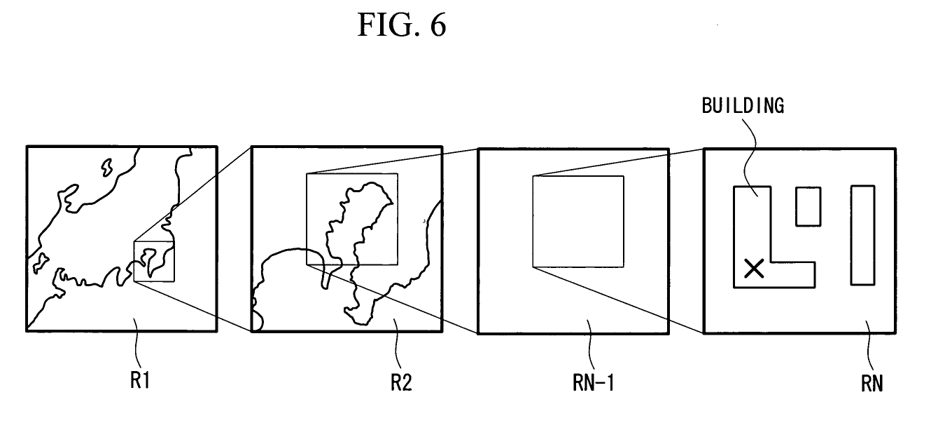

For example, when a diffusate is released at the target point X shown in FIG. 6 and an operator inputs initial conditions required for calculation, such as the calculation start time, the meteorological-modeling unit 11 of the gas-condition predicting device 10 calculates meteorological parameters, using a meteorological model, at a plurality of evaluation points defined in enlarged areas R1 to RN-1 (see FIG. 6) that are larger than a target area RN (see FIG. 6) for an evaluation period starting from the prediction start time (calculation start time) input as an initial condition to the prediction completion time at predetermined time intervals (for example, every 10 minutes) (step SA1 in FIG. 5).

More specifically, the meteorological-modeling unit 11 is connected to the meteorological database 7 via the communication unit 6 (see FIG. 1) and downloads meteorological data for the above evaluation period, for example, the GPV data, which is nationwide weather observation data. Subsequently, the initial conditions and the boundary conditions are determined on the basis of the GPV data, and meteorological parameters at higher resolutions are sequentially determined using a nesting method.

In this step, temporal interpolation and spatial interpolation are performed using the GPV data, thereby calculating the boundary conditions in the enlarged area R1 shown in FIG. 6 and calculating the initial conditions every 10 minutes. For example, well-known methods can be employed to calculate the boundary conditions and the initial conditions in detail. For example, the method described in the related art in Japanese Unexamined Patent Application, Publication No. 2002-202383 can be employed.

When the initial conditions and the boundary conditions in the enlarged area R1 having a scale corresponding to the GPV data are determined as described above, a fundamental equation of wind-speed field analysis, which is a partial differential equation for analyzing atmospheric phenomena and which is represented by the regional atmospheric modeling system (RAMS) code, is calculated in terms of a difference solution using these conditions. The variables of the equation are output as difference solutions (that is, meteorological parameters at each evaluation point at intervals of 10 minutes).

When the meteorological parameters at each of the evaluation points defined in a grid shape in the enlarged area R1 are calculated at intervals of 10 minutes as described above, an enlarged area R2 that includes the target area RN and that has an area smaller than that of the enlarged area R1 is defined in the enlarged area R1, and meteorological parameters at each evaluation point defined in a grid shape in this enlarged area R2 are calculated at intervals of 10 minutes.

In the meteorological-modeling unit 11, among the evaluation points in the enlarged area R2, at evaluation points located at the same positions as the evaluation points defined in the enlarged area R1, since the meteorological parameters have already been calculated in the calculation in the enlarged area R1, the meteorological parameters are diverted without further processing to serve as the initial conditions in the enlarged area R2. At other evaluation points, data obtained by interpolating the above diverted meteorological parameters is used as the initial conditions. Next, among the evaluation points around the boundary of the enlarged area R2, at evaluation points located at the same positions as the evaluation points defined in the enlarged area R1, the meteorological parameters in the enlarged area R1 are diverted without further processing to serve as the boundary conditions. At other evaluation points around the boundary, data obtained by interpolating the above diverted meteorological parameters is used as the boundary conditions. By solving partial differential equations relating to atmospheric phenomena using these initial conditions and boundary conditions, the meteorological parameters at each evaluation point are calculated at intervals of 10 minutes. When the calculation of the meteorological parameters in the enlarged area R2 is finished, an enlarged area R3 that includes the target area and that has an area smaller than that of the enlarged area R2 is then defined in the enlarged area R2, and initial conditions and boundary conditions are calculated by the same procedure as that described above. By solving partial differential equations relating to atmospheric phenomena using these conditions, meteorological parameters at each evaluation point are calculated at intervals of 10 minutes.

Thus, meteorological parameters having progressively higher density in a smaller area are calculated step by step. When meteorological parameters at intervals of about 100 m are finally obtained in the enlarged area RN-1 at intervals of 10 minutes, the meteorological parameters at each evaluation point in this enlarged area RN-1 are output to the extraction unit 12 and the correction unit 13.

When the extraction unit 12 receives the meteorological parameters at each evaluation point in the enlarged area RN-1, the extraction unit 12 determines atmospheric conditions in the target area from the meteorological parameters in the enlarged area RN-1 (step SA2 in FIG. 5) and extracts gas flow-field data corresponding to the atmospheric conditions from the auxiliary memory device 3 (step SA3 in FIG. 5). For example, the extraction unit 12 selects meteorological parameters, such as wind speed, wind direction, and the amount of solar radiation, at a single evaluation point corresponding to the target area RN in the enlarged area RN-1 and calculates the atmospheric stability from the selected wind speed and the amount of solar radiation. The extraction unit 12 then extracts from the auxiliary memory device 3 gas flow-field data corresponding to the atmospheric conditions determined by the combination of the wind direction and the atmospheric stability. Alternatively, the extraction unit 12 may determine the atmospheric conditions on the basis of the average of meteorological parameters at a plurality of evaluation points in the target area RN. The atmospheric stability may be calculated using the amount of radiation budget instead of the amount of solar radiation.

When the extraction unit 12 extracts the gas flow-field data as described above, the extraction unit 12 outputs the extracted gas flow-field data to the correction unit 13.

When the correction unit 13 receives the gas flow-field data from the extraction unit 12 and the meteorological parameters at each evaluation point in the enlarged area RN-1 at intervals of 10 minutes from the meteorological-modeling unit 11, the correction unit 13 corrects the gas flow-field data extracted from the extraction unit 12 using the meteorological parameters at each evaluation point in the enlarged area RN-1 (step SA4 in FIG. 5).

The correction unit 13 corrects the gas flow-field data by, for example, assimilating the meteorological parameters at each evaluation point in the enlarged area RN-1 and the gas flow-field data. In this case, for example, the assimilation is performed only for wind components in the gas flow-field data. A nudging method can be used as this assimilation method.

The nudging method is a method of making a calculation result of the meteorological analysis model approach an observed value by taking account of observed values or calculation results of another model in the calculation results of a certain model. A basic equation of the nudging method is represented by equation (1):

$$\frac{\partial φ}{\partial t} = ɛ ( {φ}_{0} - {φ}_{before} ) \qquad ( 1 )$$

In equation (1), φ₀ represents an observed value, ε represents a weighting coefficient, and φ_{before} represents a calculated value before assimilation. Equation (1) is represented by equation (2) in the form of a finite difference.

$$\begin{matrix}\frac{{φ}_{after} - {φ}_{before}}{Δ t} = ɛ ( {φ}_{0} - {φ}_{before} ) \\ That is , & ( 2 ) \\ {ϕ}_{after} = {ϕ}_{before} + ɛ \cdot Δ t ( {ϕ}_{0} - {ϕ}_{before} ) & ( 3 )\end{matrix}$$

In equations (2) and (3), φ_{after} represents a calculated value after assimilation.

In equation (3), the calculated value φ_{before} before assimilation is corrected by the second term on the right side. That is, when the calculated value φ_{before} before assimilation is smaller than the observed value φ₀, the second term on the right side acts so as to increase the calculated value φ_{before} before assimilation. On the other hand, when the calculated value φ_{before} before assimilation is larger than the observed value φ₀, the second term on the right side acts so as to decrease the calculated value φ_{before} before assimilation. Thus, the calculated value φ_{after} after assimilation is calculated.

In this embodiment, calculation is performed by substituting the meteorological parameters of the wind calculated by the meteorological-modeling unit 11 for the observed value φ₀ in equation (3) and substituting the gas flow-field data of the wind extracted by the extraction unit for the calculated value φ_{before} before assimilation in equation (3), thus calculating the gas flow-field data of the wind after assimilation.

This assimilation of the gas flow-field data may be performed, for example, only for evaluation points near the boundary in the target area. Alternatively, the assimilation may be performed for all evaluation points common to the enlarged area RN-1 and the target area RN, or any other evaluation point.

When the correction unit 13 corrects the gas flow-field data of the wind extracted by the extraction unit 12 on the basis of the meteorological parameters of the wind calculated by the meteorological-modeling unit 11 using equation (3), the correction unit 13 outputs the gas flow-field data of the wind after correction and gas flow-field data in other meteorological parameters that are not corrected. This gas flow-field data output from the correction unit 13 is output to the diffusion calculation unit 15 in the diffusion-condition predicting device 20 via the output unit 14.

The diffusion calculation unit 15 performs a diffusion calculation using the gas flow-field data input from the output unit 14, thereby predicting the diffusion conditions of the diffusate released from the target point X shown in FIG. 6 at intervals of 10 minutes. The calculation results obtained from the diffusion calculation unit 15 are displayed on the output device 5, such as a monitor.

As described above, according to the diffusion-condition predicting system of this embodiment, atmospheric conditions and gas flow-field data of a target area under the atmospheric conditions are stored in the auxiliary memory device 3 in advance. Accordingly, the meteorological-modeling unit 11 need not calculate the gas flow-field by a meteorological model calculation to the level of the target area RN, thus reducing the processing time.

Furthermore, the gas flow-field data extracted from the auxiliary memory device 3 is gas flow-field data in which meteorological parameters at that time are reflected. In addition, this gas flow-field data is corrected using the meteorological parameters at that time. Therefore, highly accurate gas flow-field data can be obtained.

In the above embodiment, the correction unit 13 assimilates only wind components, but the embodiment is not limited thereto. The correction unit 13 may assimilate other meteorological parameters. For example, assimilation can also be performed for turbulence energy, humidity, and temperature.

In particular, regarding the above-described wind components and turbulence energy, these meteorological parameters are important parameters in the diffusion calculation in the diffusion-condition predicting device 20. Accordingly, by correcting the wind components and the turbulence energy, the prediction accuracy of the diffusion conditions in the diffusion-condition predicting device 20 can be further improved.

In the description of the above embodiment, the nudging method is used as the assimilation method, but the assimilation method is not limited thereto. For example, a least squares method described below may be used.

In this least squares method, when physical quantities of model A at a certain grid point (i, j, k) are represented by X_{ai,j,k}, physical quantities of model B at the same grid point are represented by X_{bi,j,k}, and all the grid points are targeted, a coefficient α that minimizes M represented by equation (4) is calculated. By multiplying this coefficient α by a calculated value before assimilation, a calculated value after assimilation is obtained.

$$M = {\sum }_{i = 1}^{NX} {\sum }_{j = 1}^{NY} {\sum }_{k = 1}^{NZ} {( {X}_{ai , j , k} - α {X}_{bi , j , k} )}^{2} \qquad ( 4 )$$

In equation (4), NX, NY, and NZ represent the number of grid points in the X, Y, and Z directions, respectively. In equation (4), since Xₐ and X_{b} in each grid point are given, M is represented by a quadratic expression of equation (5). Accordingly, the coefficient α that minimizes M can be calculated by solving the quadratic equation when M=0.

$$\begin{matrix}M = {\sum }_{i = 1}^{NX} {\sum }_{j = 1}^{NY} {\sum }_{k = 1}^{NZ} ( {X}_{ai , j , k}^{2} - 2 α {X}_{ai , j , k} {X}_{bi , j , k} + {α}^{2} {X}_{bi , j , k}^{2} ) \\ = {\sum }_{i = 1}^{NX} {\sum }_{j = 1}^{NY} {\sum }_{k = 1}^{NZ} ( {Z}_{bi , j , k}^{2} ) \cdot {α}^{2} - 2 {\sum }_{i = 1}^{NX} {\sum }_{j = 1}^{NY} {\sum }_{k = 1}^{NZ} ( {X}_{ai , j , k} {X}_{bi , j , k} ) \cdot α + \\ {\sum }_{i = 1}^{NX} {\sum }_{j = 1}^{NY} {\sum }_{k = 1}^{NZ} ( {X}_{ai , j , k}^{2} )\end{matrix} \qquad ( 5 )$$

When the coefficient α when M=0 is calculated as described above, the correction unit 13 multiplies this coefficient α by the gas flow-field data of the wind before assimilation to obtain the gas flow-field data of the wind after assimilation.

This assimilation of the gas flow-field data may be performed for only evaluation points near the boundary in the target area. Alternatively, the assimilation may be performed for all evaluation points common to the enlarged area RN-1 and the target area RN, or any other evaluation point.

In addition to the above gas flow-field data of the wind, other meteorological parameters, such as turbulence energy, temperature, and humidity, may be used as the data for the assimilation.

### Second Embodiment

A second embodiment of the present invention will now be described.

A diffusion-condition predicting system of this embodiment differs from the diffusion-condition predicting system of the above-described first embodiment in the function of the extraction unit 12.

Regarding the diffusion-condition predicting system of this embodiment, a description of the structure common to the first embodiment is omitted, and only structure different from the first embodiment will be described.

When the extraction unit 12 of this embodiment receives meteorological parameters at each evaluation point in the enlarged area RN-1 from the meteorological-modeling unit 11, the extraction unit 12 extracts atmospheric conditions relating to the boundary of the target area in the enlarged area RN-1 and calculates the averages of these meteorological parameters. For example, the extraction unit 12 selects meteorological parameters, such as wind direction, wind speed, and the amount of solar radiation, at a plurality of evaluation points in the boundary of the target area RN in the enlarged area RN-1 and calculates the averages of these meteorological parameters, that is, the average wind direction, the average wind speed, and the average amount of solar radiation.

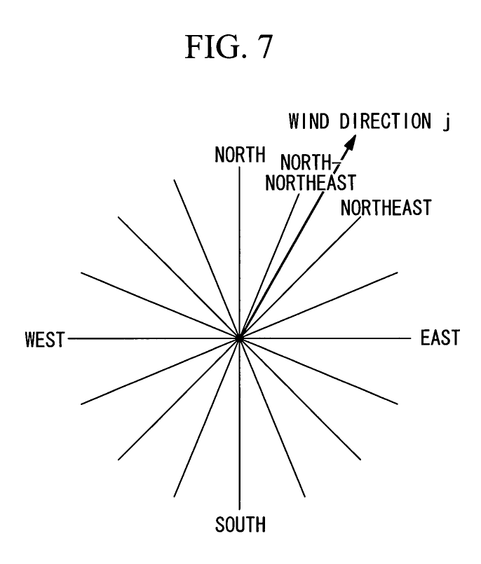

The extraction unit 12 then calculates the average atmospheric stability from the average wind speed and the average amount of solar radiation. In addition, the extraction unit 12 selects two wind directions on either side of the average wind direction. For example, as shown in FIG. 7, when the average wind direction j lies between north-northeast and northeast, north-northeast and northeast are selected as the two wind directions on either side of the average wind direction j. The extraction unit 12 then extracts from the auxiliary memory device 3 two types of gas flow-field data specified by the two selected wind directions (north-northeast and northeast in the above example) and the average atmospheric stability.

The gas flow-field data in the target area is then calculated by performing linear combination of the two types of extracted gas flow-field data.

For example, when the gas flow-field data extracted from the auxiliary memory device 3 is represented by Φs and Φt, the extraction unit 12 linearly combines Φs and Φt using equation (6) to calculate gas flow-field data anew in the target area:

Φnew=αΦs+βΦt. (6)

In equation (6), α and β represent weighting values determined by the relationship between the average wind direction and the two wind directions on either side of the average wind direction. A known method can be used for the above linear combination.

When the extraction unit 12 calculates the gas flow-field data in the target area as described above, the extraction unit 12 outputs this gas flow-field data to the correction unit 13.

When the correction unit 13 receives the gas flow-field data from the extraction unit 12 and the meteorological parameters at each evaluation point in the enlarged area RN-1 at intervals of 10 minutes from the meteorological-modeling unit 11, the correction unit 13 corrects the gas flow-field data by assimilating the meteorological parameters at each evaluation point in the enlarged area RN-1 and the gas flow-field data. In this step, for example, the assimilation is performed only for the wind components in the gas flow-field data. This assimilation method is the same as that in the first embodiment.

As described above, according to the diffusion-condition predicting system of this embodiment, the gas flow-field data in the target area is calculated by extracting atmospheric conditions relating to the boundary of the target area included in the enlarged area RN-1, extracting two types of gas flow-field data from the auxiliary memory device 3 on the basis of the averages of meteorological parameters, and performing linear combination of the two types of extracted gas flow-field data. Accordingly, more accurate gas flow-field data can be calculated. By performing a diffusion calculation using this gas flow-field data, the accuracy of the diffusion calculation can be improved.

In the above embodiments, the gas flow-field data is specified using wind direction and atmospheric stability, but the embodiments are not limited thereto. For example, wind speed may be used instead of the atmospheric stability. In this case, the gas flow-field data can be specified by wind direction and wind speed.

In the above embodiments, the correction unit 13 assimilates the gas flow-field data, after linear combination, which is input from the extraction unit 12, and the meteorological parameters at each evaluation point in the enlarged area RN-1, which are input from the meteorological-modeling unit 11, and then outputs the gas flow-field data after assimilation to the output unit 14. Alternatively, the correction unit 13 may output the gas flow-field data, after linear combination, which is input from the extraction unit 12 without performing such an assimilation process. Thus, such an assimilation process may be omitted.

Furthermore, in the second embodiment, the average wind direction and the average atmospheric stability are determined using only meteorological parameters in the boundary of the target area RN in the enlarged area RN-1. Alternatively, the average wind direction and the average atmospheric stability may be determined using meteorological parameters at all evaluation points in the target area RN.

Embodiments of the present invention have been described in detail with reference to the drawings. However, the specific structure is not limited to these embodiments, and design changes and the like are also included in the present invention so long as they do not depart from the essence of the present invention.

For example, in the above embodiments, the atmospheric conditions are determined by the combinations of atmospheric stability and wind direction, but meteorological parameters for specifying the atmospheric conditions are not limited to these parameters.

In the above embodiments, a description has been made of the case where the meteorological parameters are calculated at intervals of 10 minutes, but the time interval for calculating the meteorological parameters is not limited to this example.

In the above embodiments, a description has been made of the case where all arithmetic operations are executed on a single computer device, but the embodiments are not limited to this example. A plurality of computer devices may be used. For example, when gas conditions over a calculation period from calculation start time to calculation completion time is calculated with a plurality of computer devices, a divided calculation period calculated by dividing the total calculation period by the number of computer devices is assigned to each computer device.

For example, when gas conditions over a calculation period three hours after the calculation start time are calculated with three computer devices, the divided calculation period assigned to each computer device is one hour. More specifically, the first computer device is assigned the period from the calculation start time to one hour thereafter, the second computer device is assigned the period from 1 to 2 hours after the calculation start time, and the third computer device is assigned the period from 2 to 3 hours after the calculation start time. The processing time can be further reduced by using a plurality of computer devices as described above.

What is claimed is:

1. A gas-condition predicting device for predicting gas conditions in a target area including a target point, comprising:
a storage unit configured to store each atmospheric condition in association with gas flow-field data in the target area under the atmospheric condition;
a meteorological-modeling unit configured to calculate, using a meteorological model calculation, meteorological parameters at a plurality of evaluation points defined in an enlarged area that includes the target area; and
an extraction unit configured to determine atmospheric conditions in the target area from the meteorological parameters calculated by the meteorological-modeling unit and to extract from the storage unit gas flow-field data corresponding to the atmospheric conditions.

2. The gas-condition predicting device according to claim 1, wherein the extraction unit determines the atmospheric conditions in the target area from the meteorological parameters calculated by the meteorological-modeling unit, extracts from the storage unit two types of gas flow-field data close to the atmospheric conditions, and performs linear combination of the two types of extracted gas flow-field data to calculate the gas flow-field data in the target area.

3. The gas-condition predicting device according to claim 1, further comprising:
an output unit configured to output the gas flow-field data extracted by the extraction unit.

4. The gas-condition predicting device according to claim 1, further comprising:
a correction unit configured to correct the gas flow-field data extracted by the extraction unit using the meteorological parameters calculated by the meteorological-modeling unit.

5. The gas-condition predicting device according to claim 4, wherein the correction unit assimilates the meteorological parameters of the target area included in the enlarged area and the gas flow-field data extracted from the extraction unit.

6. The gas-condition predicting device according to claim 4, further comprising:
an output unit configured to output the gas flow-field data obtained after the correction by the correction unit.

7. The gas-condition predicting device according to claim 4, wherein the correction unit performs an assimilation using at least one of wind components and turbulence energy of the gas flow-field data.

8. The gas-condition predicting device according to claim 1, wherein the gas flow-field data is determined using a computational fluid dynamics (CFD) model.

9. A diffusion-condition predicting system comprising:
the gas-condition predicting device according to claim 1,
wherein a diffusion calculation is performed using the gas flow-field data in the target area determined by the gas-condition predicting device.

10. A gas-condition predicting method for predicting gas conditions in a target area including a target point, comprising:
a meteorological-parameter calculation step of calculating, using a meteorological model calculation, meteorological parameters at a plurality of evaluation points defined in an enlarged area that includes the target area;
an atmospheric-condition determination step of determining atmospheric conditions of the target area on the basis of the meteorological parameters calculated in the meteorological-parameter calculation step; and
an extraction step of extracting gas flow-field data corresponding to the atmospheric conditions determined in the atmospheric-condition determination step from a storage device in which each atmospheric condition is associated with gas flow-field data in the target area under the atmospheric condition in advance.

11. A gas-condition predicting program for predicting gas conditions in a target area-including a target point, the gas-condition predicting program causing a computer to execute:
meteorological-parameter calculation processing for calculating, using a meteorological model calculation, meteorological parameters at a plurality of evaluation points defined in an enlarged area that includes the target area;
atmospheric-condition determination processing for determining atmospheric conditions of the target area on the basis of the meteorological parameters calculated in the meteorological-parameter calculation processing; and
extraction processing for extracting gas flow-field data corresponding to the atmospheric conditions determined in the atmospheric-condition determination processing from a storage device in which each atmospheric condition is associated with gas flow-field data in the target area under the atmospheric condition in advance.
